(19) United States
(12) Patent Application Publication
(10) Pub. No.: US 2017/0218793 A1
(43) Pub. Date: Aug. 3, 2017

(54) MULTI STAGE VAPOR COMPRESSION FOR HIGH EFFICIENCY POWER PRODUCTION AND HEAT PUMP

(71) Applicant: Vasileios Ethimios STYLIARAS, Patra (GR)

(72) Inventor: Vasileios Ethimios STYLIARAS, Patra (GR)

(21) Appl. No.: 15/530,491

(22) PCT Filed: Jul. 29, 2015
(86) PCT No.: PCT/GR2015/000038

§ 371 Date: Jan. 24, 2017

(30) Foreign Application Priority Data
Jul. 30, 2014 (GR) 20140100409
May 14, 2015 (GR) 20150100217

(51) Int. Cl. F01K 25/08; B01D 53/14; B01D 1/28; C09K 5/04; F01K 7/16

(52) U.S. Cl. CPC F01K 25/08; C09K 5/04; F01K 7/16; B01D 1/2884; B01D 53/1406; B01D 2252/60

(57) ABSTRACT

The method combines different electrolyte solutions having the same solvent. The solution is successively compressed and vaporized at different temperatures and the vapor is successively absorbed by the second solution that exhibits higher negative deviation, at higher temperature. The absorption heat of each absorber is recovered by the next evaporator. The more evaporator-absorber pairs that are used the higher the temperature lift or the created pressure ratio. Finally the vapor returns to the first solution at high temperature. Electrolyte is dissolved and rejected from each solution to achieve total heat recovering and the very high efficiency of the cycle. Gas absorption is suggested instead of solvent vapor.

This invention refers to a method of thermal compression of a liquid solution and its application for heat transfer like absorption heat pumps and power production from medium temperature heat sources.

The most common way of heat transfer from lower to higher temperature, otherwise the way for heat upgrading, is based on vapor compression cycle. In this cycle, a liquid is vaporized at the desired cooling temperature. The vapor is compressed, condensed rejecting heat, expanded and vaporized again. When compression is performed trough a mechanical compressor, the cycle is call mechanical compression cooling cycle. Instead, the vapor may be absorbed (condensed) by a liquid solution of the vapor substance. The solution is mechanically compressed and driven to an evaporator where it is partially vaporized. Now heat is consumed for compressing and the cycle is called thermal compression or absorption cycle. The evaporation heat of a substance is higher when evaporation takes place from a solution than from the pure substance. It leads to a transfer coefficient of almost n=0.7 for absorption heat pumps. The solution has the same concentration in the evaporator as in the absorber. The pressure ratio between these two equipments depends on their temperature difference.

There is another application suggested, where a saturated solution is cooled from an absorber where it is at high temperature, to lower temperature. This may be an electrolyte solution. The solubility and consequently the concentration decreases. Another phase, like crystals of electrolyte, is created and separated from the solution. The resulting lower concentration solution is vaporized and the vapor is compressed and driven to absorber. The remaining solution is driven to absorber too and the initial solution is reformed. Alternatively, the lower concentration solution is compressed and heated up to the absorber temperature. It is partially vaporized and the vapor performs a cooling or power cycle and then is absorbed in the absorber. The remaining liquid solution returns to the absorber to where the separated electrolyte is driven to, to form the initial solution. Absorption heat is recovered by the evaporator.

The vapor pressure of a solution depends not only on the temperature but of the nature of the solute and the concentration as well. The vapor pressure of the low concentration solution is higher than that of the high concentration at the same temperature. Pressure gradient is established between the two solutions although they are at the same temperature. In the same way, two solutions may vaporize at the same pressure but different temperature. The vapor pressure of a solution is P=aP⁰=γmP⁰, where: P⁰ is the pressure of pure solvent, a is the activity, γ is the activity coefficient which is a function of the nature of the solvent and solute and the solution concentration as well. m is the molar concentration.

The present invention combines two different solutions having the same solvent. The second solution activity does not depend straight with the first solution and may now be much lower than that of the first one, leading to high temperature lift. Vapor is produced by the first solution evaporation at low temperature and absorbed by an absorber of the second solution. Cooling, heating and expansion ratio are created directly by the solution evaporation and absorption. There is no need for additional evaporators and condensers. The second solution is compressed and heated up to the first solution absorber temperature. It is vaporized there and the vapor returns to the first solution while the rest of the solution returns to the second solution absorber. A few evaporators at different temperature are used for the first solution and each evaporator is combined with an absorber of the second solution so that the rejected heat from the one absorber is recovered by an evaporator forming absorber-evaporator pairs. If the absorption takes place at the same with the evaporation pressure, temperature lift is achieved, while if the absorption takes place at the same with the evaporation temperature expansion ration and work production is achieved. Each pair contributes to a temperature or pressure lift. Higher power production is achieved per vapor mass. The after all gradient is proportional to the pairs used. The temperature lift or expansion ratio may be much higher making the application commercially exploitable. In addition, an intermediate solution concentration change cycle or an intermediate evaporator-absorber is added to make the gradient higher without extensive system complication. Besides the use of a gas-liquid solution is presented that overcomes practical problems that may appear from the electrolyte separation. A higher pressure ratio in each pair is achieved by gas dissolution-release from the solution. The first solution concentration may be considerably changed and used simultaneously in the place of the second solution.

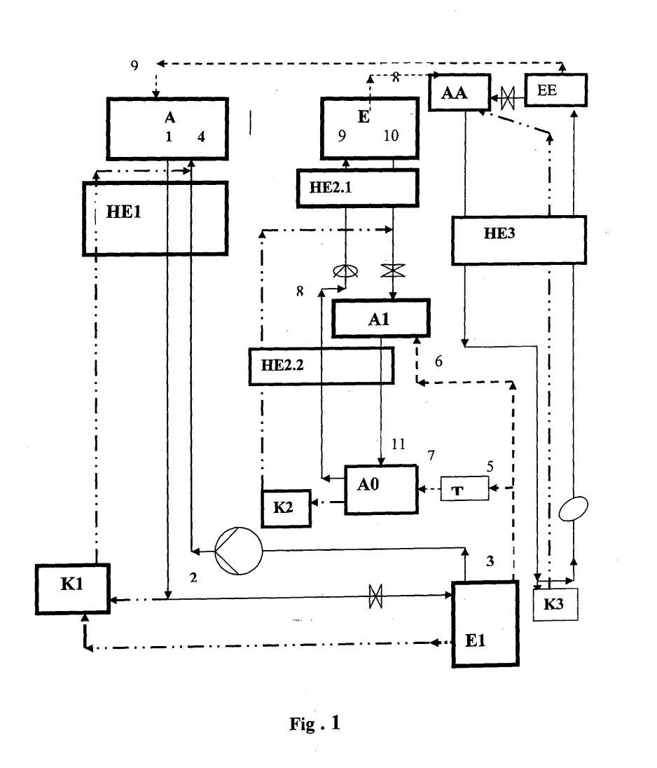

FIG. 1 shows a single stage application. (A) is the absorber where from the first solution starts cooling from high to low concentration passing through heat exchanger (HE1). (E1) is the first low concentration solution partial evaporator, (E) is the second solution evaporator, (A1) and (A0) are the second solution partial absorbers, (HE2.1) and (HE2.2) are the second solution heat exchangers, (AA) is an intermediate absorber, (EE) is an intermediate evaporator and (HE3) is a heat exchanger of the intermediate solution. (K1), (K2) and (K3) are separated phase (usually electrolyte crystals) storages. (T) is vapor expansion turbine. There are liquid pumps and expansion valves also.

In each figure, the bold line is the first liquid solution circulation, the thin line is the second liquid solution circulation, the broken line is the vapor circulation and the double dot/broken line is the separated phase (electrolyte) circulation.

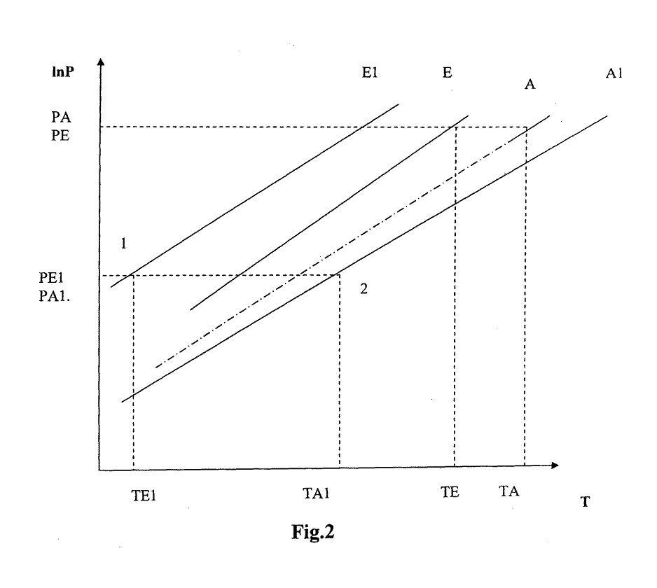

FIG. 2 is a temperature-pressure (T versus lnP) diagram for the cycle of FIG. 1 when vapor from (E) is driven straight to (A). The inclined lines are constant concentration lines of (E1), (E), (A) and (Al). Evaporator (E)1 and absorber (A1) are at the same pressure, PE1−PA1 and PA=PE when (AA) and (EE) are not used.

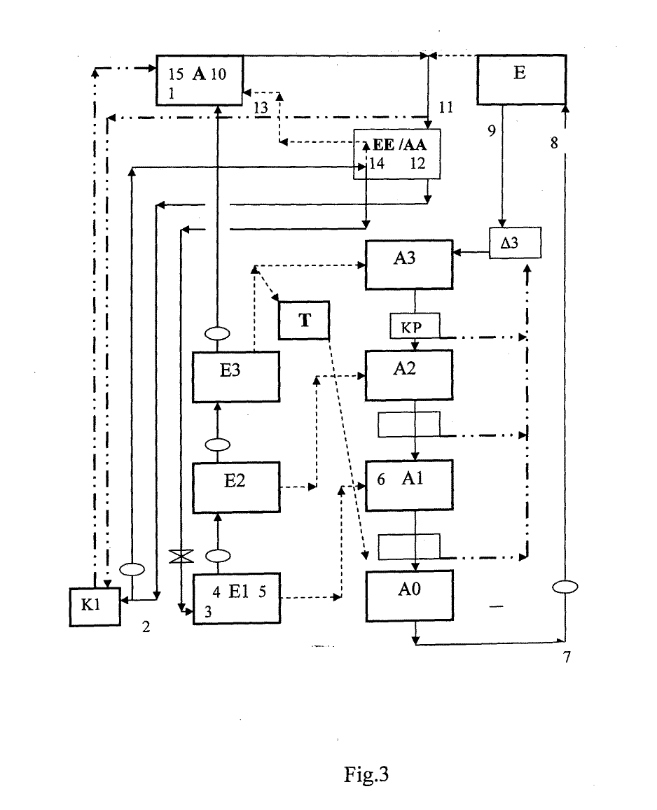

FIG. 3 shows a multi stage application. (E1), (E2), (E3), are the partial evaporators of the first solution. (A1), (A2), (A3), are the partial absorbers of the second solution. The first evaporator forms the first pair with the first absorber and so on. (A0) is a partial absorber of the second solution that may be used or omitted. (EE/AA) is an intermediate evaporator/absorber represented in the same equipment, (KP) is equipment for electrolyte crystal separation, (Δ3) is equipment for electrolyte dissolution.

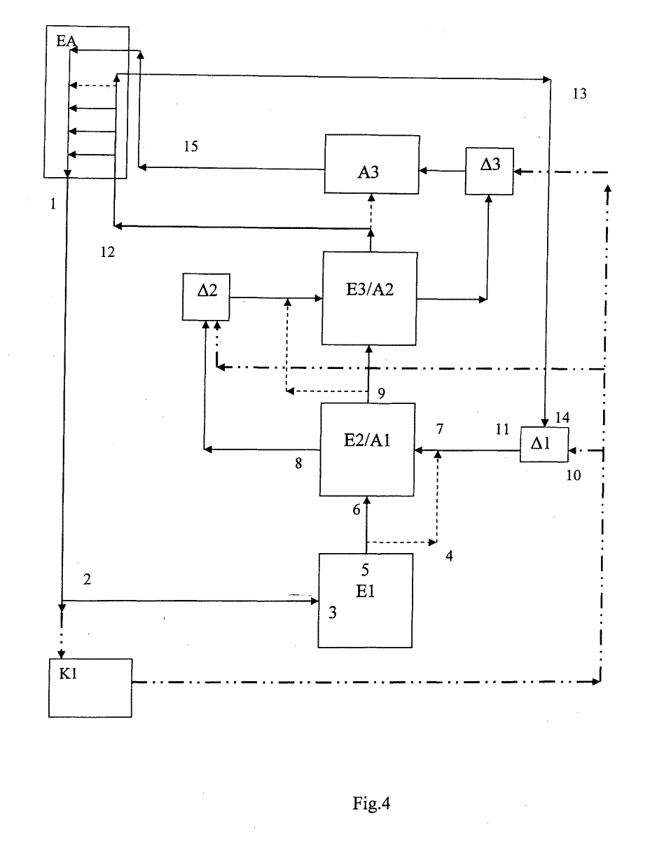

FIG. 4 shows the case where gas is dissolved in a liquid solvent. The first solution plays the role of the second solution too. Evaporator (E2) and absorber (A1) as well as evaporator (E3) and absorber (A2) are shown in the same equipment. (Δ1), (Δ2), (Δ3) are electrolyte dissolution equipments. (EA) is the heat exchanger where gas is released from the high gas concentration solution and absorbed by the low gas concentration solution later.

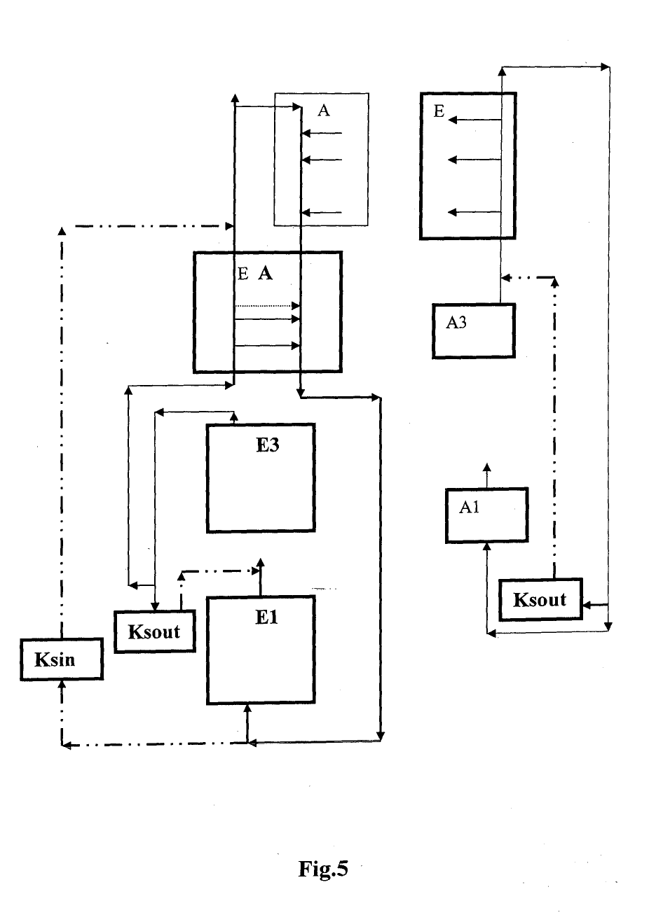

FIG. 5 is the case where the first solution is driven to absorber (A) through the heat exchanger-absorber (EA). This is the case where a “salt out” effect electrolyte is added before an evaporator and rejected from the solution leaving the last evaporator. A similar case is when a “salt out” electrolyte is used in the second solution evaporator (E) to make the solution leaving (A3) saturated. (Ksout) is the storage of the electrolyte.

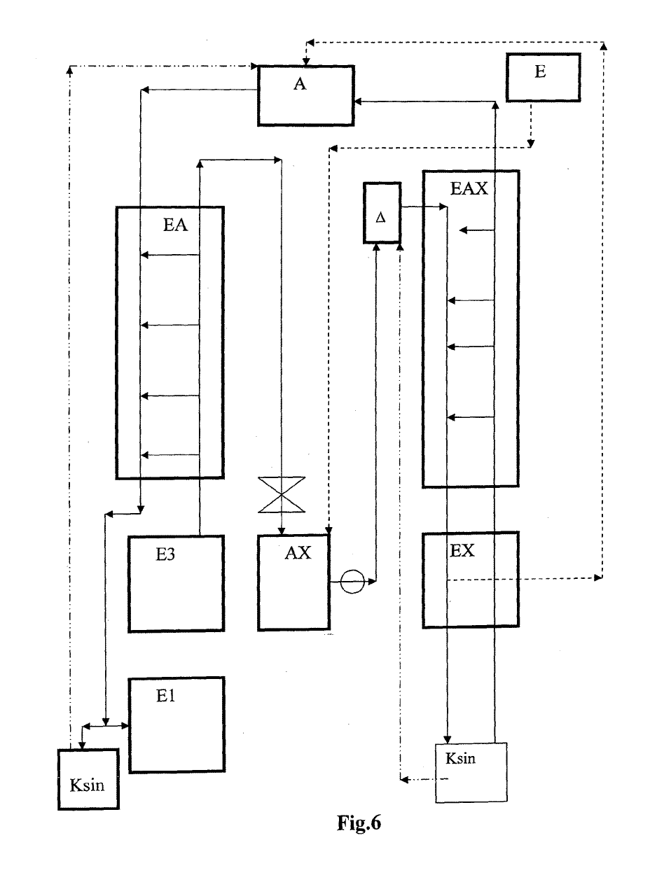

FIG. 6 is the case of gas-liquid solution where the vapor from (E) is absorbed at lower temperature by an absorber (AX) and released from an evaporator (EX) which works at the (AX) temperature. Another heat exchanger-absorber-evaporator (EAX) is used.

All the solutions engaged in the method have liquid solvent where a solute of different melting point is dissolved in. The most usual and convenient solutes are the electrolytes. Practically the solutions are supersaturated but when solute is to be separated the electrolyte is forced to crystallize at the concentration of saturation by the known methods. When solubility degreases and different phase is formed, this phase is electrolyte crystals in case of using electrolytes. This term is also used here for simplicity. The case of using gas that is released from the solution, is characterized as vapor also, as vapor is a gas phase.

The first solution starts vaporizing at low temperature and concentration and then it is brought at high temperature and solute is dissolved into this, to be able to absorb vapor at the lower possible pressure. The second solution absorbs vapor at high concentration and then rejects electrolyte to be able to evaporate at high pressure.

FIG. 1 depicts the method when a single stage compression is applied for simplicity. A first, preferable electrolyte, solution is cooled from high temperature and concentration, from an absorber (A) to lower temperature (1-2). The solubility decreases and different phase is formed. In case of using solid electrolyte solution, this different phase is electrolyte crystals. Crystal formation is enhanced by any known technique. For simplicity hereafter the separated phase will be called crystals. They are separated from the solution (2) and gathered in a storage tank (K1). The remaining lower concentration solution is expanded to an appropriate pressure so that it will vaporize at the desired cooling temperature from a first partial evaporator (E1). In case more crystals are created due to evaporation, they are gathered to the tank. The remaining solution (3) is compressed and returns (4) to the absorber (A). The separated crystals are driven to the absorber (A) too. Crystal dissolution preferably takes place before entering absorber. Fluxes moving toward the absorber recover heat from that leaving absorber through heat exchanger (HE1). Vapor is heated through this too.

Produced vapor from (E1) is driven to an absorber (A1) (points 3-6). There it is absorbed by a second solution. This solution has the same solvent as the first one but different electrolyte(s) consistency. It has different electrolytes or the same at higher concentration when the absorption temperature is much higher than evaporation temperature. Finally the second solution is selected to have much lower activity than the first, so that absorption temperature is higher than evaporation at the same pressure or absorption pressure is lower than evaporation at the same temperature. As an example, the vapor pressure of a low concentration aqua solution (4M) is in the range 30 mbar (45° C.) and the pressure of a high concentration solution (80% NaOH) is 0.1 mbar.

Separated crystals are usually wet. Solvent is transferred on them. They may come to the convenient pressure so that this solvent is vaporized and driven to the absorber.

There from, the solution is cooled and enters an auxiliary absorber (A0) (11). Separated crystals are gathered in a tank (K2) while the solution is compressed (8) and driven to an evaporator (E) (9) where it is partially vaporized. The rest of the solution (10) is expanded and driven back to absorber (A1). Heat exchange takes place between solutions that are cooled and heated through heat exchangers (HE2.1.) and (HE2.2). The vapor (8) from (E) is driven to absorber (A) where it is absorbed (another option is presented in FIG. 1). Pressure and temperature of (A) and (E) are regulated so as they are the same in each equipment. Absorption heat is recovered from evaporator. Increasing the absorption temperature, the solubility of the first solution increases and the activity lowers, while the concentration of the second solution in (E) is not temperature depended as it remains the same with the lower temperature solution. In this way (A) and (E) may come to the same pressure and temperature.

As an example suppose the temperature of (A) is TA=170° C. and the concentration at this temperature is M=40 mole. The solution (first solution) is cooled to 2° C. where the concentration is 5M and the vapor pressure is P=10 mbar=PE1. An aqua ZnCl2 solution is used as a second solution. Then the pressure of A1 is PA1=PE1=10 mbar. From a P-T-M (crystallization line) chart of this solution the solubility is 45M at TA1=100° C. This solution is cooled to 20° C. where the concentration is 30M. This is also the concentration of (E). The vaporation temperature of (E) at TE=170 and M=30 results PE=1.5 bar=PA. Removing of electrolyte may achieved by adding another electrolyte having a common ion with the dissolved one. The solubility decreases and part of the electrolyte is removed. The new solution is cooled and the additive is removed. As an example, if Zn(ClO3)2 is the main electrolyte and KClO3 is the added at high temperature, part of Zn(ClO3) is removed. Cooling the solution, KClO3 is removed too as the solubility at 0° C. is 0.3M while at 140° C. is 9M.

The higher the activity difference between the first and the second solution at the lower temperature, the higher the absorber (A) temperature. To reduce the temperature of (A), a further vapor compression is applied. The vapor (8) from (E) is absorbed from an intermediate absorber (AA) that is at the same pressure and has a concentrated solution. The solution is cooled rejecting electrolyte which is gathered at a tank (K3) and then the solution is compressed and driven to an evaporator (EE), where it is partially vaporized. The remaining solution is expanded and returns to absorber (AA) while the vapor is absorbed by the absorber (A). Absorber (AA) and evaporator (EE) work at the same temperature, not necessarily the same with (A). (EE) and (A) as well as (AA) and (E) work at the same pressure level. A heat exchanger (HE3) is also used. An intermediate absorber-evaporator may also be used using the leaving (A) solution. This case is included in

FIG. 3, where the leaving (A) solution is cooled, enters (AA) (11)to absorb vapor coming from (E) or the previously described (EE) (14) evaporator. The result is cooled rejecting electrolyte, compressed and enters (EE) where it is partially vaporized. Vapor enters (A)(13), while the solution is driven to (E1) (3).

The vapor produced from the first solution vaporization at (E1), may be expanded through a turbine (T) and absorbed from the absorber (A0) (5-7) FIG. 1. Absorber A0 and evaporator E1 may work at the same temperature and absorption heat recovered from evaporator. (A0) may be the first absorber where the second solution starts circulating and from there solution enters (A1).

A multi stage evaporation-absorption process may be applied. The first solution is successively evaporated at different temperature and compressed before entering (A). Vapor from each evaporator is absorbed by a corresponding absorber. The rejected heat from each absorber is recovered by the next evaporator.

This embodiment is explained in FIG. 3. Leaving (E), the low concentration second solution is driven to the last absorber (A3) and from there it is expanded and enters next absorber until it leaves from the first absorber (A0). Electrolyte is dissolved before (A3) and is removed, before the next absorber so that the solution is saturated in each absorber. As solvent enters in each absorber, the solution may be saturated without removing electrolyte. Leaving (A1), the solution is further cooled to achieve the lower possible concentration and moves to (E). The first solution starts vaporizing from the first evaporator (E1), is compressed and enters (E2), compressed again and enters (E3) and from there compressed again to enter (A). Vapor from (E1) enters (A1), from (E2) enters (A2) and from (E3) enters (A3).

The second solution may move the opposite direction, starting from (A1): The vapor (5) leaving evaporator (E1) is absorbed by absorber (A1) at the same pressure but higher temperature(6). The remaining first solution is compressed and partially vaporized at evaporator (E2) at the temperature of (A1). The second solution is compressed and enters absorber (A2) to absorb vapor from (E2). The remaining first solution is compressed, enters (E3) where it is partially vaporized and the vapor is absorbed by (A3). The pairs of (E2)/(A1), (E3)/(A2) that work at the same temperature may be the same equipment. Suppose the unit is used for heat transfer. Heat is absorbed by the first absorber at the selected cooling temperature TE1 and rejected by (A3). If TEi, TAi, are the temperature of evaporators and absorbers, there is a temperature lift from TE1 to TA1, from TA1 to TA2 and from TA2 to TA3 which is the temperature the heat is rejected. The temperature of each absorber is determined by its concentration and the evaporator pressure. The evaporator pressure is determined by the temperature of the absorber which heat is recovered and its concentration.

As the second solution moves from the first to the last absorber, its temperature and solubility increase. Electrolyte is dissolved before each absorber to make the solution saturated (maximum concentration) and the vapor pressure low. After the last absorber, the solution is cooled and part of the electrolyte is removed and stored in a tank. Then the solution is driven to the evaporator (E) and is partially vaporized to release the vapor that was absorbed by all of the second solution absorbers. As it was stated above, this vapor is absorbed by the first solution absorber (A).

The first solution from the absorber A (1) is cooled to a lower temperature. The solubility is decreased and separated phase is formed. It is electrolyte crystals that are removed from the solution and gathered in the tank (K1). The remaining solution enters (E1).

In FIG. 3 another embodiment is presented to lower the pressure of (E). The solution is cooled at a little lower temperature, is expanded and enters (11) an intermediate absorber (AA) to absorb vapor from (E). Then (12) the solution leaves absorber, is cooled (2) rejecting electrolyte, compressed and enters (14) evaporator (EE) to be vaporized. Vapor is driven to (A) while the solution is cooled and enters (3) (E1).

The first and the second solutions may split into many fluxes. Each flux is driven to its own equipment. As an example, the first solution splits into three fluxes and each flux is driven to one evaporator. All fluxes join into the absorber (A).

In another embodiment of the invention the first solution turns to second solution. The first solution, leaving last partial evaporator (E3) is heated up to the last absorber (A3) temperature and electrolyte is dissolved to make this saturated. This solution enters absorber (A3) and acts as a second solution. Leaving partial absorbers, the electrolyte is removed and the low concentration solution enters evaporator (E1).

Alternatively, the vapor of each evaporator is expanded through a turbine and absorbed at the evaporator temperature. Absorption heat is used for evaporation. Instead of that, the evaporator—absorber pairs are used for heat upgrading and the vapor of the last evaporator is expanded and absorbed by the first absorber. To achieve high expansion ratio, absorption takes place at the lowest temperature. Another absorber (A0), is used which may work at environmental or any other temperature. The rejected heat of that absorber may be recovered by the first evaporator (E1). (A0) is now the first absorber. The rejected heat from the last absorber, may partially be used for heating purposes and partially used for the last evaporator vapor production, which vapor is expanded for power production and absorbed from (A0). The vapor may obviously be superheated and reheated before absorption.

The second solution may be partially evaporated at low temperature after electrolyte separation. The vapor is absorbed by the first solution before evaporator (E1) or condensed and used as the first solution. Electrolyte separation is not applied in the first solution when it is pure solvent. This may be applied when low temperature heat is available.

Electrolyte solutions exhibiting high negative deviation from ideal solution and solubility increase with temperature are preferred. Anhydrous solutions are also preferred. A few examples are (Li,Rb,Ba) with (Br2,I2,Cl2,SCN,ClO4), NaOH, RbOH, KOH, equal weight of NaOH/KOH mixture,ZnCl2, CoI2, SbCl2, LiIO3, (Rb,Cs)NO3, H2BO3. A mixture of those may be used. Polar solvents like H2O, methylamine, methanol, formamide, DMF, DMSO, FA, AN, NH3 are suggested while ionic liquids may be convenient too. In another embodiment of the invention, a gas-liquid solution is used. Electrolyte is added and separated from the solution to change the gas solubility or the pressure or the temperature of the gas solution.

The solubility of a gas depends on the nature of the gas and solvent, the temperature and the pressure. Increasing the temperature the solubility decreases while increasing the pressure the solubility increases. The influence of an electrolyte in the solubility is known as “salt in” and “salt out” effect. In the first case the solubility increases or the equivalent, the pressure may be reduced and the solubility remains constant. In the “salt out” case the solubility decreases or the pressure is increased to keep the solubility constant. Large polarizable ions (usually anion) have “salt in” effect. Small, multi charge ions have “salt out effect”.

The same effect is caused by dissolving an electrolyte having a common ion with the gas when the gas is an electrolyte. The solubility of an electrolyte decreases when an electrolyte having a common ion with the dissolved one is added. It is known as the “common ion” effect. As an example, if HCl is used as the gas, H2BO3 may be dissolved at high temperature. The solubility of H2BO3 at 100° C. is 6M while at 0° C. is 0.5M. Dissolving H2BO3 at high temperature the HC1 solubility is reduced or the pressure may be increased to keep concentration constant. Removing this additive the solubility increases (more gas may be dissolved at the same pressure and temperature). Cooling the solution the H2BO3 is totally removed. Slightly soluble or “insoluble electrolytes are preferred as additives in any case so that they removed at low temperature. The term “gas” is used to indicate a substance much more volatile than the solvent.

In this embodiment, a gas-liquid solution is partially vaporized so that part of the gas is released and then absorbed by another solution. The process depicts in FIG. 5. Partial evaporators and absorbers are not shown in this figure as they are the same as in FIG. 3. The solution is vaporized in an evaporator (E1). Released gas is absorbed by another solution in the absorber (A1). The remaining liquid is compressed and enters evaporator (E2) where it is again partially vaporized. Released gas is absorbed by the second solution in (A2) and so on. In order to achieve temperature lift or expansion ratio as in previous embodiment, the second solution must have lower activity, meaning that it has lower gas concentration and or different solvent.

The second solution that leaves the last partial absorber, enters evaporator (E) where it is heated and vaporized so that the previously absorbed by the partial absorbers gas is released. The first solution, after leaving the last evaporator, is also heated through heat exchanger (EA) to release gas and reduce its concentration. A “salt in” electrolyte is dissolved in the solution, heated to the highest evaporator (E) temperature and enters absorber (A) to absorb the gas coming from (E). The first solution in (A) has reduced its concentration that much as it approaches the activity of the second solution in (E). (A) and (E) operate at the same temperature and pressure.

Leaving absorber (A), the solution passes through exchanger (EA) to absorb the gas that was released there and is cooled to reject the electrolyte. Rejecting electrolyte, the solubility decreases but the temperature has also decreased. Next the solution enters evaporator (E1). Heat recovering takes place in (EA) and between (A) and (E).

To avoid concentration increase in the second solution due to gas absorption, the solution exits partial absorber and is driven to (E) to reject the gas and returns to the next partial absorber.

To increase the pressure difference between the first and the second solution, the “salt out”, “salt in”, “common ion” effects may be applied. The degree of application depends on the efficiency-installation cost relation.

A “salt out” electrolyte is dissolved after first evaporator and rejected through solution cooling after the last one (E3). The solution is expanded (to reduce its pressure) before entering (EA). In this way the first solution is compressed to higher pressure for the same gas solubility without effect on the pressure of (A). The solution may be cooled after (EA) to reject the electrolyte increasing the solubility and then heated again absorbing gas from (E) and then from (EA). The “salt in” electrolyte dissolution in (A) may be avoided. In the same way, a “salt in” electrolyte is dissolved into the second solution before the second absorber and is rejected after the last one. Absorption pressure decreases for the same gas solubility without pressure effect on (E). A “salt out” or “common ion” electrolyte is dissolved in the second solution before entering (E) when it is not saturated to make it saturated. When the solution is saturated, the solution leaving last absorber (A) is cooled and the “salt out” or “common ion” electrolyte is dissolved there to make it saturated at that lower temperature. The solution starts heating and rejecting gas from that lower temperature. The evaporator E works now at lower temperature. The additional electrolyte is rejected by solution cooling after (E). If the leaving (A) solution is already saturated, it may be compressed before electrolyte dissolution. The vaporization pressure of (E) increases in this way. Solution pressure regulation takes place before (E) (increase) and after electrolyte extraction (expansion). The same with the “salt out” effect, may be caused by using an electrolyte having a common ion with the gas, when the gas is an electrolyte. In case the method is applied for power production, the temperature is upgraded from (E1) to (A2). Absorption heat from (A2) is used to evaporate (release gas) from (E3). Gas from (E3) is expanded and absorbed by (A0). Evaporator (E3) is at higher pressure than (A2). The solution leaving (A2) is compressed and a “salt out” is added so that vaporization may happen at higher pressure. A “salt in” is added in the first solution after (EA).

In another embodiment, the same solvent is used for the second solution. The first solution, exiting the exchanger (EA) has low gas concentration. It is used as the second solution. It is driven to absorbers and after that the “salt in” electrolyte is dissolved into this and the solution comes to exchanger (EA) to absorb the gas that was released there. Then it is compressed and cooled to reject the electrolyte and enters evaporator (E1). All other alternative related to “salt in”, “salt out” effect may be applied.

To retain the pressure of (E) low, the released from there gas is absorbed at low temperature by the first solution that exits (EA). The method is shown in FIG. 6. The solution is cooled, expanded to the pressure of (E) and enters absorber (AX) to absorb gas from (E). Then the solution is compressed to the pressure of (E3), a “salt in” electrolyte is dissolved, heated and enters heat exchanger (EAX) to be cooled and absorb the gas that is released there. Then gas is released at the evaporator (EX), the remaining solution is cooled to reject electrolyte and driven to (EAX) to be heated and reject more gas (the gas that previously absorbed in (EAX). The gas released from (EX) is dissolved in (A). The absorber (AX) operates at the same temperature with (EX) and (A) at the same temperature with (E) so that heat is recovered. The “salt out” effect may also be applied and the electrolyte is rejected before (AX). The rejected heat from the solutions that are cooled is always recovered by those that are heated. As an example, the concentration of the solution leaving (E3) is 0.6, leaving (EA) is 0.4, one mole is coming from (E) and the concentration of the solution entering (EAX) is 0.5. Two moles are absorbed in (EAX) and the solution enters (EX) with concentration 0.7. One mole is released and driven to (A). The solution enters (EAX) with concentration 0.6 and exits with 0.4 Enter (A) and exit with 0.5, enters (EA) and exits with 0.7. Enters (E1), is partially vaporized in partial absorber and exits (E3) at 0.6.

There are data for many gas-liquid solutions. A few solvents convenient for the application are: 1Ethyl-3-methyl-phospholine-1 oxide, DME-TEG, DME-TEG/Tetramethylurea (75/25), with Freon 30, Freon 21, and 22 and DMA,DMF,DEF with Freon 21,11,22 e.t.c. Lets see the application of Dimethyl Ether of Tetraethylene Glycol (DMF-TEG) as solvent with Freon 22 as gas. The partial absorber pressure is selected to be 0.3 (constant). No electrolyte is involved to examine a simple case.

The first solution in E1 has a concentration of x=0.75 (mole fraction). The evaporation temperature is 28 C (83 F) and the pressure 70 psia. It is partially vaporized and its concentration is reduced. The released gas (freon) is absorbed by the second solution absorber A1 at concentration x=0.3, pressure 70 psia and temperature 88 C (190 F). The remaining first solution is compressed and vaporized in E2 at 88 C, x=0.7 and pressure 260 psia. The gas is absorbed by A2 at x=0.3, p=260 psia and t=160 C (320 F). The remaining first solution is vaporized in E3 at x=0.65, t=160 C and p=450 psia. The gas is absorbed in A3 at x=0.3, p=450 psia and t=180 C (360 F). This is the temperature the heat is rejected (upgraded).

The vapor of (E3) may be expanded and absorbed by absorber (A0) at t=TE=28 ° C. In the first case where the solvent is vaporized, the solution from absorber (A1) is compressed, heated and enters evaporator (E) where it is vaporized. The vapor enters absorber (A) at higher temperature. The resulting solution is cooled to reject electrolyte, heated again and enters evaporator (E1) at the temperature of (A) so that the absorption heat is recovered by evaporation. The solution comes out of (E1), the separated electrolyte is dissolved in, expands and enters absorber (A). the vapor is condensed at evaporator (E) temperature offering heat for vaporization, cooled, expands at refrigeration temperature and enters absorber (A1).

### REFERENCES

1. STYLIARAS Vasileios PCT/GR2013/000012

2. B. J. Eiseman, Jr.ASHRAE JOURNAL, 1, 45, No. 12, December 1959: “A Comparison of Fluoroalkane Absorption Refrigerants”

1. Method of vapor thermal compression for heat transfer and power production combining two or more, solutions of different activity but the same solvent which is transferred as vapor from one solution to the other, where
the solutions preferably exhibit high negative deviation from ideal, the solute is preferably soluble solid electrolyte(s), the solutions consisting of different electrolyte(s) so as the first solution has higher solvent activity,
the first solution is compressed and partially vaporized (E1), (E2), (E3) successively at higher temperature levels,
the produced vapor from each evaporation is absorbed into a corresponding partial absorber (A1), (A2), (A3) from the second solution, which is gradually compressed after each absorber,
each evaporator is connected to a corresponding absorber, so that absorption takes place at the evaporation pressure and higher temperature, which temperature is the temperature that the next evaporation takes place recovering absorption heat,
each evaporator is also connected to a corresponding absorber, through a work production vapor expansion turbine, with its expansion pressure corresponding to an absorption temperature equal to the first solution evaporation temperature,
the heat of the last partial absorber is partially used for heating and partially used for the first solution vaporization so that vapor is produced and expanded through a turbine (T) and absorbed by a second solution absorber (A0) at low or first evaporator (E1) temperature,
the second solution electrolyte(s) is dissolved before each absorber to make the solution saturated at the absorption temperature,
the second solution leaving the last absorber, is cooled so that electrolyte crystals are formed and separated from the solution, while the remaining solution is compressed, heated up to a convenient temperature and enters an evaporator (E) where it is partially evaporated to release the vapor that has been absorbed from the partial absorbers,
the first solution leaving last partial evaporator is compressed and heated up to the same pressure and temperature of the second solution evaporator (E), while first solution electrolyte(s) have been dissolved into this to make the solution saturated,
the first solution enters an absorber (A) and absorbs the vapor coming from evaporator (E),
the absorption heat of (A) is recovered by the evaporator (E), while the absorption temperature has been selected so as the electrolyte solubility gives a solution activity equal to that of the evaporated second solution,
the first solution formed into the absorbed (A) is cooled to reject the dissolved electrolyte, the remaining solution pressure is regulated and driven to the first partial evaporator (E1),
heated solutions, vapor and separated electrolytes recover heat from the cooled solutions,
electrolytes like (Li,Rb,Ba) with (Br2,I2,Cl2,SCN,ClO4), NaOH, RbOH, KOH, equal weight of NaOH/KOH mixture,ZnCl2, CoI2, SbCl2, LiIO3, (Rb,Cs)NO3, H2BO3, or a mixture of those may be used, while polar solvents like H2O, methylamine, methanol, formamide, DMF, DMSO, FA, AN, NH3, ionic liquids may be used.

2. Method of vapor thermal compression for heat transfer and power production as in claim 1 where the vapor released from the second solution evaporation (E) is absorbed by a concentrated solution in an intermediate absorber (AA),
this solution is cooled and rejects electrolyte, then is compressed, heated recovering heat from the cooled solution and enters an intermediate evaporator (EE) where it partially evaporates,
the solution is expanded and returns to the absorber (AA) while the vapor enters first solution evaporator (A)

3. Method of vapor thermal compression for heat transfer and power production as in claim 1 where the first solution is cooled to a selected temperature and there (AA) absorbs vapor coming from second solution evaporator (E),
the resulting solution is further cooled to reject electrolyte as in claim 1,
is compressed, heated recovering heat from the below stated cooling solution and enters an intermediate evaporator (EE) where it is partially vaporized,
the remaining solution is expanded and driven to first partial evaporator (E1), while the vapor is absorbed in the absorber (A).

4. Method of vapor thermal compression for heat transfer and power production as in claim 1, where the first solution exiting last partial evaporator (E3), comes to the first absorber temperature,
more electrolyte is dissolved to make the solution saturated,
the resulting solution enters first absorber playing the role of the second solution and exiting last absorber and rejecting electrolyte, enters partial evaporator (E1).

5. Method of vapor thermal compression for heat transfer and power production as in claim 1, where the second solution after electrolyte rejection, is heated and evaporates at a selected temperature,
the vapor is condensed and enters first evaporator, consisting the first solution, while absorber A and evaporator A are omitted.

6. Method of vapor thermal compression for heat transfer and power production as in claim 1, where the solution from first absorber (A1) is compressed, heated and enters evaporator (E) where it is partially vaporized,
the remaining solution is cooled, expanded and enters absorber (A1),
the vapor enters absorber (A) where it is absorbed at a selected higher than (E) temperature,
the solution is cooled rejecting electrolyte, compressed, heated up to the absorber (A) temperature and is partially vaporized at (E1) that is now at the absorber(A) temperature,
the remaining solution exits evaporator (E1) and the rejected electrolyte is dissolved into this,
the solution is expanded and enters absorber (A),
absorption heat from (A) is used for evaporation at (E1), while temperature and pressure of (E1) are selected so as the vapor is condensed at the evaporator (E) temperature,
the vapor is condensed at the evaporator (E) temperature offering the heat for evaporation, is cooled and expanded to a pressure corresponding to the desired cooling temperature,
the liquid is vaporized and enters absorber (A1),
heated solutions recover heat from the cooling solutions, while the solution of (A1) is not necessarily saturated.

7. Method of vapor thermal compression for heat transfer and power production as in claim 1, where a gas has been dissolved in the solution so that this gas is now released as vapor instead of the solvent vapor, the solvent may be different in each solution and electrolyte dissolution and rejection is applied for effecting gas solubility, where,
the first solution has higher gas concentration and activity from the second so as its vaporization pressure is higher,
the solution coming out of the last evaporator (E3) is further heated through heat exchanger (EA) to reduce its gas concentration,
a salt in effect electrolyte is dissolved,
the solution is heated and enters absorber (A) to absorb gas released from (E),
the solution passes through heat exchanger (EA) to absorb the gas that was released there, is cooled to reject the electrolyte,
the solution pressure is regulated and the solution enters evaporator (E1),
the second solution electrolyte, if used, is a “salt in” electrolyte,
the second solution coming out from the last in the row absorber and rejecting the salt in electrolyte that was dissolved, regulate its pressure, heated and enters evaporator (E) where it is partially evaporated.

8. Method of vapor thermal compression for heat transfer and power production as in claim 7, where
a salt out or common ion electrolyte is dissolved before second partial evaporator (E2) and rejected after the last one
a salt out or common ion electrolyte is dissolved in the second solution before evaporator (E) when the solution is not saturated, while when the solution is saturated, it is compressed first or the solution is cooled before (E) and the electrolyte is dissolved at that lower temperature turning it to saturated solution and electrolyte is rejected by solution cooling after coming out of (E).

9. Method of vapor thermal compression for heat transfer and power production as in claim 8, where the second solution which the salt out or common ion electrolyte has been dissolved in, is cooled to reject the electrolyte after coming out of the heat exchanger (EA),
the solution is heated going to absorber (A).

10. Method of vapor thermal compression for heat transfer and power production as in claim 7 where the first solution after heat exchanger (EA) is cooled, expanded, enters absorber A1, dissolves electrolyte playing the role of the second solution,
the solution after the last absorber (A3), comes at the heat exchanger (EA) pressure and passing through this, absorbs the gas previously released there and being cooled rejects electrolyte, compressed and enters evaporator (E1).

11. Method of vapor thermal compression for heat transfer and power production as in claim 7 where the first solution after heat exchanger (EA) is cooled and expands to the evaporator (E) pressure,
enters an auxiliary absorber (AX), absorbs the gas coming from (E), is compressed, heated, dissolves (Δ) a salt in effect electrolyte, enters an absorber heat exchanger (EAX) and is driven to an auxiliary evaporator (EX) where it is partially evaporated,
the remaining solution is cooled to reject electrolyte (K), absorbs the previously rejected gas passing through the absorber heat exchanger (EAX) and enters absorber (A),
the released in evaporator (EX) gas is absorbed by the absorber (A),
absorber (AX) and evaporator (EX) work at the same temperature so that the absorption heat is recovered from evaporation,
absorption heat rejected from (EAX) is also recovered by the gas released there,
all heating streams recover heat from the solutions that are cooled.

12. Method of vapor thermal compression for heat transfer and power production as in claim 7 where the second solution after each absorber is driven to the evaporator (E) to release the absorbed gas and returns to the next absorber.

13. Method of vapor thermal compression for heat transfer and power production as in claim 7, where the gas released from the evaporators are absorbed by the absorbers at the same pressure, where the gas released from the last evaporator is partially absorbed by an absorber (A0) at low temperature,
the absorption in (A0) takes place at any temperature as it is the environmental temperature or the first evaporator (E1) temperature,
the second solution is compressed and a salt out or common ion electrolyte is dissolved into this before evaporator (E),
a salt in electrolyte is dissolved into the first solution after (EA).
